(19) United States
(12) Patent Application Publication
(10) Pub. No.: US 2009/0102616 A1
(43) Pub. Date: Apr. 23, 2009

(54) TIME-BASED ACCESS CONTROL FOR AN ENTERTAINMENT CONSOLE

(75) Inventors: Jeffrey Shane Stone, Bellevue, WA (US); Christopher Pirich, Seattle, WA (US); James N. Helm, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/876,703

(22) Filed: Oct. 22, 2007

(51) Int. Cl. G08B 1/00

(52) U.S. Cl. 340/309.9

(57) ABSTRACT

Methods and systems for controlling access to a multi-purpose entertainment console are disclosed. The methods and systems allow a first user to configure the amount of time per time interval a console is available for other users to access the entertainment features of the console. In one embodiment, when a timer is activated, the timer counts down as the console is used. The console provides a series of notifications that the timer is running low and a notification when time has expired. The user may then turn off the console or ask the first user to add more time. In another embodiment, the timer can be configured with daily or weekly limits. In further embodiments, the timer and system clock may be protected by a security code to prevent tampering. In a further embodiment, the system clock can be referenced for the automatic daily/weekly time allocation to be allocated.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2006, 2007 Microsoft Corp.

### FIELD OF TECHNOLOGY

The presently disclosed subject matter relates to the field of computing, and more particularly, to fields such as entertainment consoles, although these are merely exemplary and non-limiting fields.

### BACKGROUND

Video game and entertainment systems are becoming more popular in many households, in particular in households with children. Parents who purchase gaming and entertainment consoles for their children frequently lament that they have trouble managing how much time their children use the consoles. Furthermore, parents also are concerned about how much time their children consume other forms of media such as music, TV, and movies. Many desire to enforce limits on the total time, days, and times that their children are allowed to use the consoles.

Currently a number of methods are available for managing the use of such consoles. In hardware implementations, consoles are typically managed by plugging the console's power outlet to the hardware device, and shutting off power to the console when a hardware timer expires. A number of software based control mechanisms for managing the use of electronic devices are also available. Typically, such software based control mechanisms simply restrict use of the console as a function of the rating or classification of the game being played, for example, when the game is classified as inappropriate for a certain age group. Other software control mechanisms may provide means to restrict access to games, but the mechanisms are directed to general PC environments and games that are played therein. In an Internet-based environment there are control mechanisms hosted by online gaming systems that provide a web interface to schedule game play. Other control mechanisms are designed to block access to certain Internet web sites. Such mechanisms are not directed to gaming and entertainment consoles and thus are not integrated with the capabilities of such consoles and the gaming environment in particular. Furthermore, such control mechanisms are easily tampered with and do not provide robust and secure features.

### SUMMARY

Various systems, methods, and computer readable instructions are disclosed herein for providing a time control mechanism for controlling access to a video game, and in particular to a multi-purpose entertainment device or console that can be used for games, music, video, instant messaging, and the like. In one exemplary and non-limiting aspect of the present disclosure, a timer is provided that users can employ to manage how much time a device can be used for various activities during a particular time period, for example a day or a week or some other period of time.

In various embodiments, the time control mechanism provides interfaces that provide the user the option of configuring the amount of time per day or per week that they want to allow their children to have access to the various entertainment features of the console. In one embodiment, when the play timer is activated the timer can count down as the console is used. The system then provides a series of notifications to the user that their time is running low, and ultimately, a notification that their time has run out. At this point the child has the option of turning off the console or asking the user to add more time.

In one aspect, the timer can be configured with daily limits. Alternatively, the user can manage their play time over entire weeks with the timer automatically adding the allocated time at the beginning of a specified time period. If the allocations are set to daily limits, then at a given time each day the timer can be reset (for example, each day at 3:00 a.m. the timer can be set to 2 hours). Alternatively, if the system is configured for weekly limits then the timer can be replenished weekly (for example, on Monday at 3:00 a.m. the timer is set to 14 hours).

In order to provide system security and prevent tampering with the control settings, in one embodiment, the timer is protected by a security code that can be created by the user. In a further embodiment, the system clock can be referenced for the automatic daily/weekly time allocation to be set. The system clock can be synchronized when the user is online using an internet based gaming service. However, if the user is not connected to the internet, the clock can be manually set. Alternatively, a system clock can be used to provide a time reference.

Various exemplary features of the present disclosure include: (1) integration of the above features into a gaming system's operating systems; (2) integrated time management of the various media consumption features of the console; (3) notification via system messages on the game display notifying users of time remaining; and (4) an application programming interface (API) through which an application can determine at any time whether the timer is set and if so how much time is left.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are illustrated. However, the disclosure is not limited to the specific aspects shown. The following figures are included:

FIG. 1 illustrates exemplary components for providing a timer control system in an entertainment console;

FIG. 2 illustrates an exemplary process for providing a timer control system in an entertainment console;

FIG. 3 illustrates an exemplary display providing access to a timer control system;

FIG. 4 illustrates an exemplary display providing the current time remaining in a timer control system;

FIG. 5 illustrates an exemplary display indicating the expiration of play time in a timer control system;

FIG. 6 illustrates an exemplary display providing the current status in an entertainment console including play time remaining;

FIG. 7 illustrates security features that may be provided in conjunction with a timer control system;

FIG. 8 illustrates an exemplary display providing the current time remaining in conjunction with an application operating in an entertainment console;

FIG. 9 illustrates an exemplary console for subject matter discussed in FIGS. 1-8;

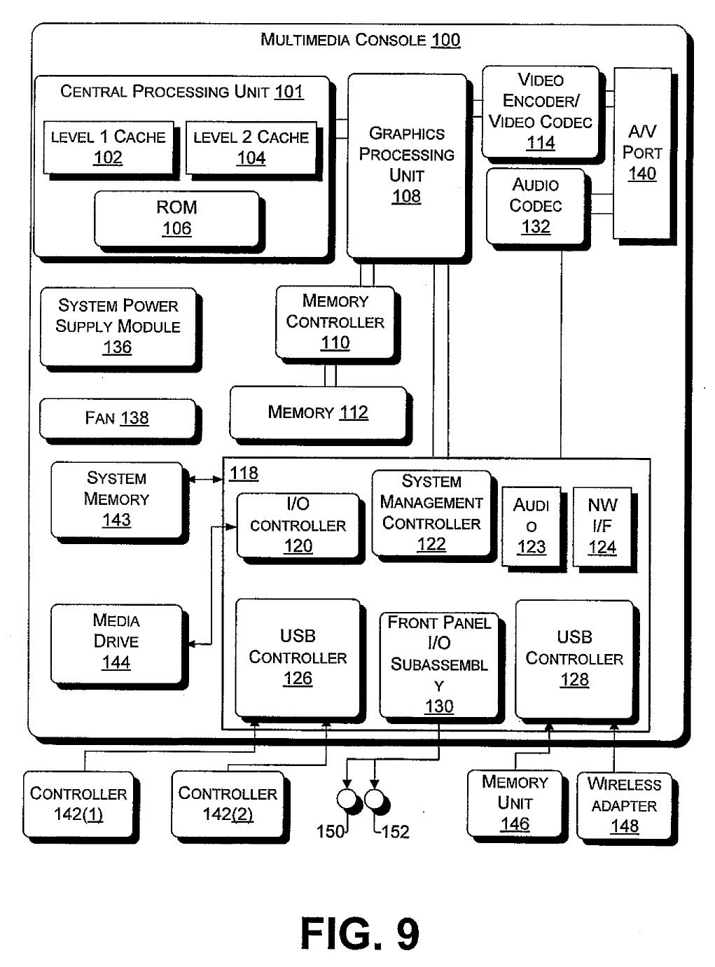

FIG. 10 illustrates an exemplary computing environment for subject matter discussed with reference to FIGS. 1-8; and

FIG. 11 illustrates an exemplary networking environment for subject matter discussed with reference to FIGS. 1-8.

### DETAILED DESCRIPTION

Many video game consoles today are multi-purpose entertainment devices that can be used for games, music, video, instant messaging, and the like. In various embodiments, methods and systems are disclosed herein for providing a time-based control mechanism for managing access to such an entertainment console.

In one exemplary and non-limiting aspect of the present disclosure, a timer is provided so that parents can manage the amount of time their children play with the entertainment console during a particular time period, for example per day or per week. In various embodiments, the timer may provide user interface components that allow the user to configure the amount of time per day or per week that they will allow their children to consume media on the entertainment console. With the play timer configured and activated, the timer will count down as the console is used. The console can then provide a notifications to the user that the playing time is running low, and ultimately, a notification that the timer has run out. At this point the child has the option of turning off the console or asking their parents to add more time.

While entertainment consoles may already possess certain family control settings, such consoles typically do not provide an integrated mechanism for parents to limit how much time their children can use the console. When such a control setting is built directly into an entertainment system's operating system, the control features may fully take advantage of the hardware and software capabilities of the system. In the methods and systems disclosed herein, various embodiments of a timer with scheduling features are disclosed. Features of such embodiments include the ability to manage play time daily during certain hours that are configurable by the user either directly on the console, or optionally, from a personal computer via a web browser.

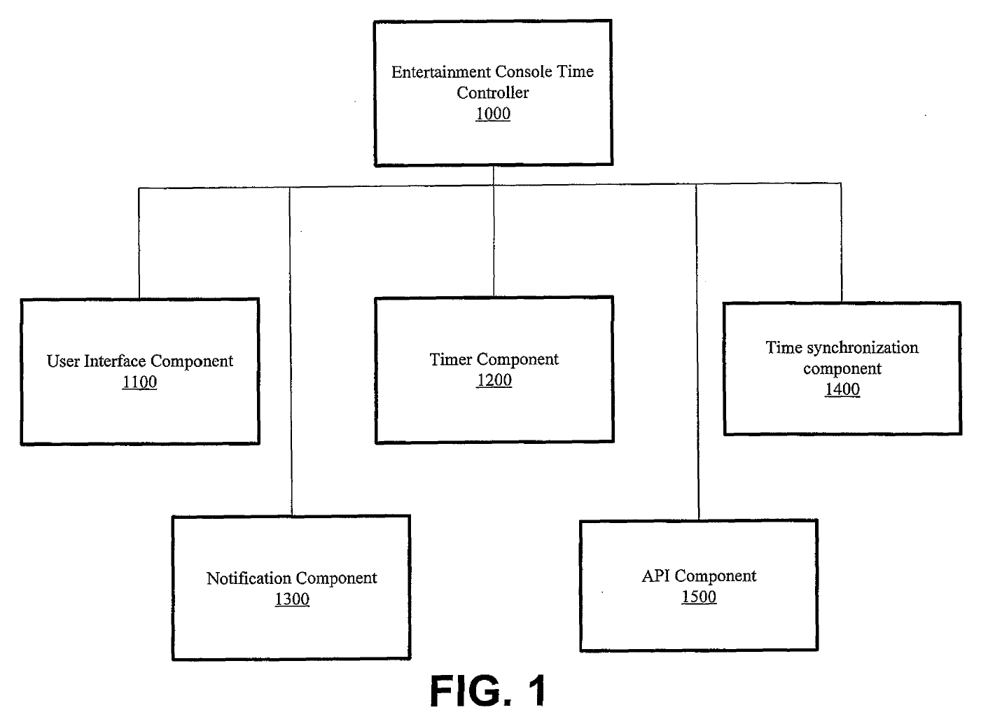

FIG. 1 depicts various components of a system that can embody a time based console controller 1000. A user interface component 1100 can be used for setting up, managing, and checking status of the timer. A timer component 1200 can be set to a specified amount of time that runs down when started. A notification component 1300 can notify users when their time is running out. A time synchronization component 1400 may be used to synchronize the timer to the game system or other time based sources. Finally, application developers can utilize the API component 1500 to, for example, learn how much time is left on the timer and take appropriate action.

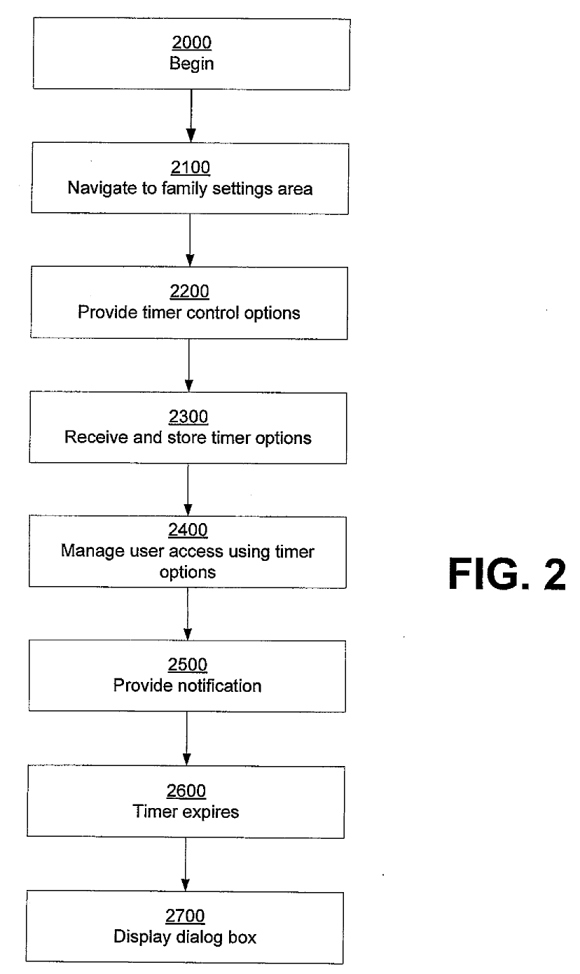

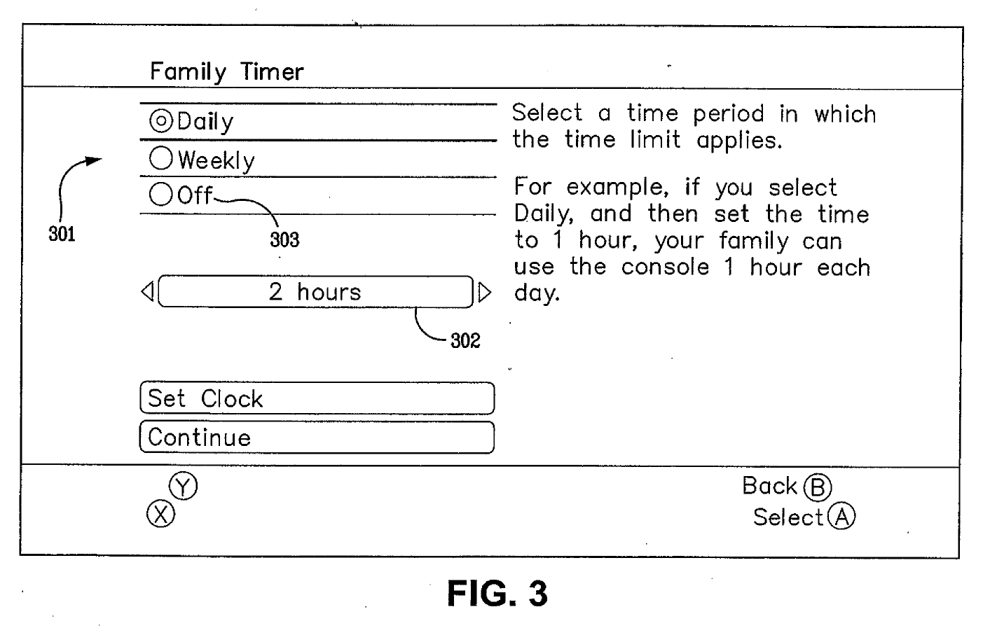

FIG. 2 depicts an exemplary process for providing time-based access control native to an entertainment console. It is noted that each operation described below may be considered a module, wherein a module can be implemented in software, hardware, or a combination of hardware and software. Beginning at operation 2000, a user may desire to set up daily or weekly time allotments for how much a console can be used and begins a session with the console. In operation 2100, the user may navigate to the family settings area on the console. In one embodiment, a console may provide an entry point to the game timer in conjunction with other family related settings. Such an area may provide access to a number of features of interest to a parent, including a control timer as well as the entry of security access codes. In the example shown in FIG. 3, three choices are shown:

301. Select a time interval,

302. Select the total time for the selected time interval, or

303. Disable the feature.

Returning to FIG. 2, the user may opt to navigate to the timer control display 2200 upon which options for time-based user access control and the configuration of time allocations are provided. The user may input timer options 2300. The various titles shown are for example only and may be implemented with other titles.

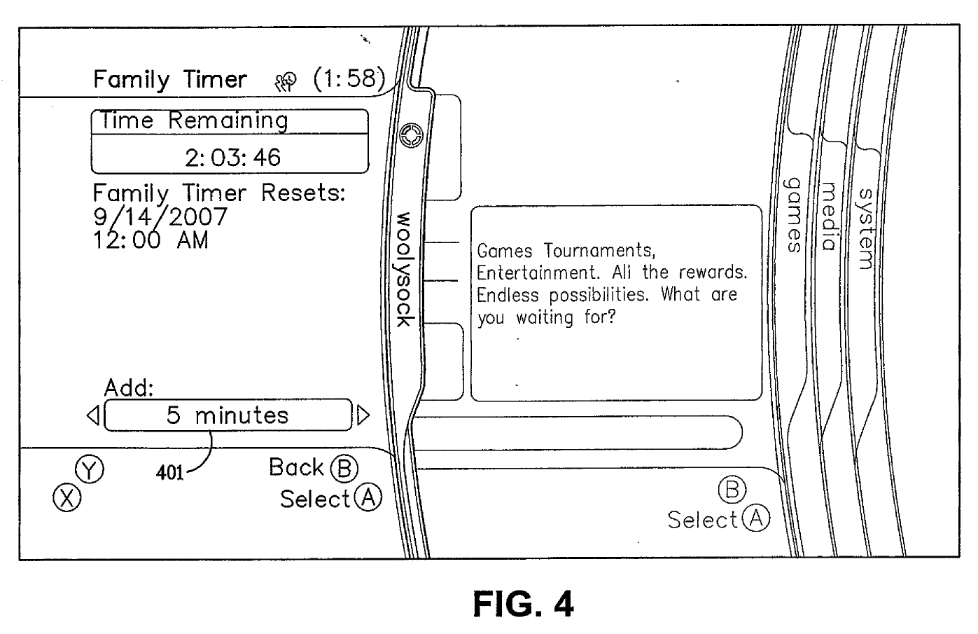

If the user has already configured a pass code the user may be requested to enter the pass code. After entering the pass code, or if the user has no pass code set, the timer configuration display will be presented. The timer configuration display may also be entered at other application levels in order to allow the timer to be accessible while games and other activities are still active. For example, the user may desire to make adjustments to an existing allocation of time. If the user chooses to just make adjustments to the day's timer allocation, the user may select additional time increments as shown in FIG. 4. As depicted in the figure, the user has run down the timer to 2 hours, 3 minutes, and 46 seconds, and is now adding 5 extra minutes 401.

Returning now to FIG. 3, the user can, for example, add time allotments to the timer in 2 hour increments and can use the radio buttons on the user interface to decide whether to have the time automatically allocated on a daily or weekly basis. The user may also select an “Off” radio button to disable the timer. The user may be able to select time segments in other increments, for example 15 minutes increments, and select segments up to a maximum limit. If the user chooses a daily allocation, the play timer may synchronize with the primary system clock, and once every 24 hours may add the allocated time to the timer. Alternatively, if the user chooses a weekly time allocation the play timer may automatically add the allocated time once per week.

When setting the timer for weekly allocations the timer may, for example, be set in 1 hour increments up to a maximum limit. In the example shown in FIG. 3, the user can, for example, decide to allocate 2 hours of console use daily. When the user sets a play allocation the console may display an interim confirmation dialog box. For example, a dialog box may indicate “you have added 2 hours per day of play time, continue and enable the play timer?” The user may then press an appropriate acknowledgement on the console controller to start the timer.

Referring back to FIG. 2, in operation 2300 the user can select the desired time control data, upon which the console can receive the user selected time control data. The operation can further store the time control data in persistent memory to preserve the settings in the case of power loss or premature system termination, as further described below.

As discussed above, the time control data will typically comprise at least a total time budget and a time interval. For example, the user may set the timer to be allocated with a play timer interval each day at 3:00 a.m., whereupon the timer will be set to the total time budget of 2 hours. In one embodiment, the console may immediately add 2 hours to the current day. In a further embodiment, the user may prefer to allocate “2 hours per day” to allocate time on selected days, for example “2 hours on each of Monday, Wednesday, and Friday.” In some embodiments the user may further select the time epoch at which the time replenishment takes place. For example, the user may allocated “2 hours on each of Monday, Wednesday, and Friday to be replenished at 3 a.m.”

Alternatively, the scheduling of specific playtimes may be implemented. For example, the user interface may include a calendar view or other view that allows users to schedule specific play times each day. For example, a user may select 3:00 p.m. to 5:00 p.m. on Monday, Wednesday, and Friday as allowable play times. Depending on whether the user prefers daily limits or prefers to provide their children the option of managing their play time over a longer period, the timer will automatically add the allocated time at the beginning of the specified time periods. The interface may also enable the user to quickly enter time increments, for example, allowing the user to add time in 15 minutes increments per day or hours per week.

If the allocations are set to daily replenishment, then at a given point or epoch of each day, the timer is allocated with the specified time interval (for example, each day at 3:00 a.m. the timer is set to 2 hours). If the timer is set to weekly replenishment, then the timer is replenished weekly (e.g., Monday at 3:00 a.m. the timer is set to 14 hours). The user may optionally provide that the current settings will be in continuous effect for a specified time period. For example, the current settings may be set to continue for the next three months, whereupon the timer settings may expire. Alternatively, the timer may be placed in effect indefinitely until the user chooses to delete or modify the timer.

In a further embodiment of the present disclosure, when the user decides to modify or delete the current timer settings, the settings may be saved in order to provide the user the option of returning to the saved settings. If the user wishes to modify a previously established setting, the user can navigate to the Family Settings area of the console, and then navigate to the control timer page. The user may further be asked to enter the previously established security access codes. The user may then modify the data control data that has previously been configured.

In a further embodiment, the console may provide an option for the user to disable the console during a specified period of time. For example, the user may allow a 2 hour daily allocation but may disable access between 9:00 p.m. until 4:00 p.m. the next day. Such a feature may be useful when the user wants the child in bed by 9:30 p.m. and sets the allocation at two hours per day play time but no later than 9:00 p.m.

Returning now to FIG. 2, the child may launch a video game or other application, upon which the console may manage the user's access to 2400 the entertainment console based upon the selected time control data. Upon launch of the application, the user may initially be provided with a notification indicating how much time remains until the timer expires.

As the user uses the console for various activities such as games, video playback, DVD playback, music, Media Center, IPTV, instant messaging, and the like, the timer continues to run. Alternatively and optionally, the timer may be configured to only decrement when selected applications are in operation. For example, the user may configure the timer to decrement when games and DVD playback is in use, but not when other applications are in use. In process 2500 the console may provide visual and/or audio or other notifications to the user as the timer continues to count down and approaches expiration. For example, a notification can be provided when the timer has 1 hour remaining, at 30 minutes remaining, at 15 minutes remaining, at 5 minutes remaining, and at 3 minutes remaining. These time increments are exemplary and notifications at other time increments may be provided.

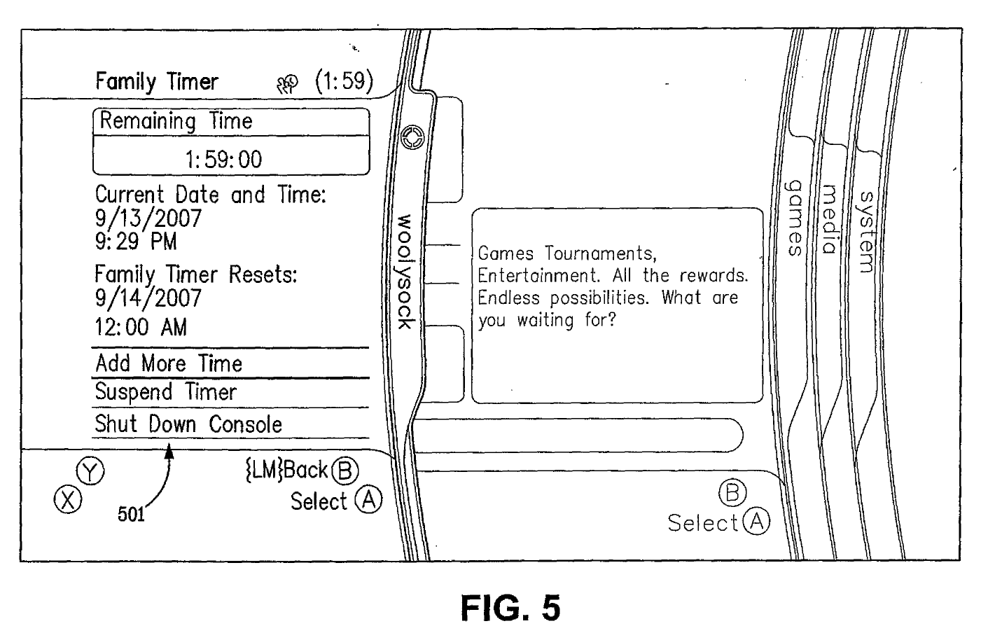

Returning to FIG. 2, the child may continue to play the video game, and after several notifications the timer may run down to zero 2600. The video game may then display a dialog box 2700 that allows the child to shut down the console or allows the user to add more time. Turning now to FIG. 5, if the user acts upon a notification, or when the timer runs out, the child may be presented with an interface that provides the option 501 to add more time, suspend the timer, or to shut down the console. Typically the child may simply choose to shut down the game console. However, the user can add more time or disable the timer all together.

In a further embodiment, the entertainment console may be configured track the system context and take action appropriate to the context. For example, when a timer expires during a video game, the system may prevent further consumption of the game, but without effecting other system activities. For example, the system may have been commanded to download a new game while the user plays a video game. Expiration of the timer should not affect the download or any other processes that are in operation.

In a further embodiment, when a video game session is started with the timer enabled but the timer has already at zero minutes remaining, the console may allow the game to be launched and may further provide a grace period during which the user may add more time. For example, a notification may be provided indicating, “Family Play Timer, 0 minutes remaining. You have 3 minutes to add more time” During the 3 minute grace period, the user can access the appropriate dialog pages as described above to add more time. The grace period may end in a manner similar to the timeout scenario described above, and provide the user options to add more time or shut down the console. The grace period time interval may be set by a user or predetermined by the console manufacturer.

It may be important for the system to provide system security features and prevent tampering with the time control data. Furthermore, in some cases users may unplug their consoles, or a power outage may cause the console to lose power. Since a loss of power typically resets the system clock, the timer control data may be protected from such occurrences.

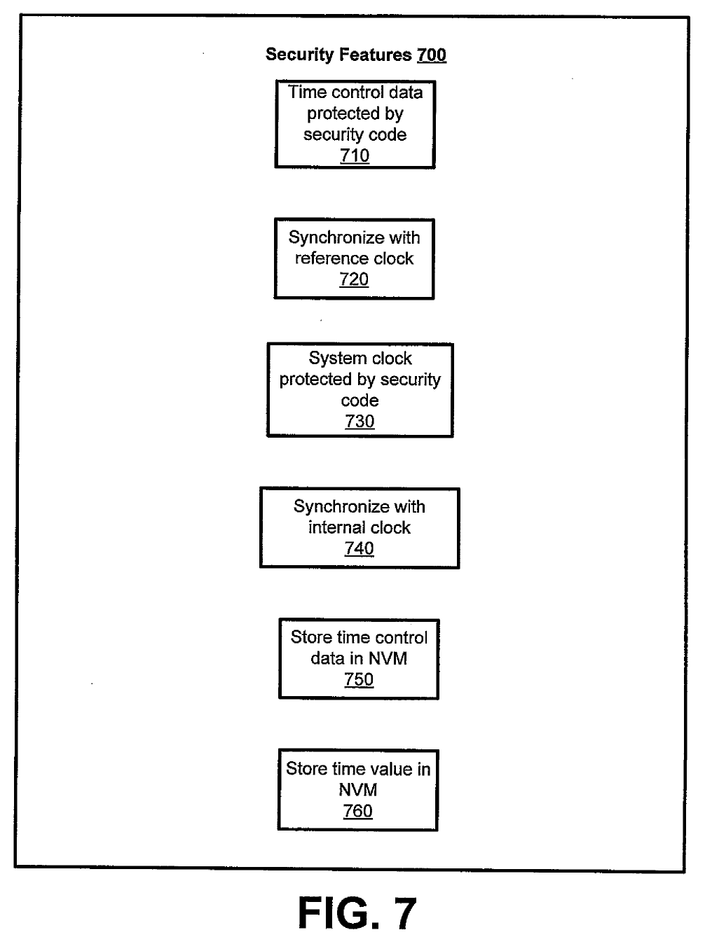

If the console loses power for any reason, for example due to a power outage or as part of an attempt to foil the clock by unplugging the console—the clock may need to be reset before the console can be used. The pass code may be requested to set the clock in this case, again preventing tampering by a child. FIG. 7 depicts various security features 700 that may be implemented to provide security and time data integrity.

In one embodiment, the timer may be protected by a security code 710 that can be created by the user as described above. For example, a pass code entered via the entertainment console may be used as the security code. This code can typically be entered before the timer setup tools can be accessed. In a further embodiment, the console can synchronize with a reference clock 720 in order for the automatic daily/weekly time replenishment allocation to be configured. The system clock can be synchronized, for example, when the user is online using an Internet based gaming service if the console is configured to receive internet based time. Alternatively, the console may subscribe to an internet based service that provides a reference clock.

However, if the console is not connected to the internet, the clock may be manually set by a user. The console may prompt the user enter a current date and time and to select a time zone. In order to ensure the security of the system master clock and to ensure that children cannot tamper with the amount of time that has been allocated, the setting of the clock may also be protected by a pass code 730. In one embodiment, the pass code may be provided as a user input any time that the user sets the clock.

In another embodiment, the console may synchronize with an internal clock 740. The internal clock may be a real time clock further powered by a battery to prevent loss of clock settings in the event of a power loss. Alternatively, the console may provide an internal clock that resets to a predetermined date and time in the event of a power loss. For example, the internal clock may be default to Jan. 1, 2000 whenever a power loss occurs. Since the timer is typically configured for daily or weekly replenishment, the timer can continue to operate with the default date and time until the user enters the correct date and time.

The time synchronization may further operate in conjunction with the current time remaining when the time remaining has been saved in persistent memory. In a further embodiment, the console may store the time control data in non-volatile memory (NVM) 750 to persist the data in the event of a power loss. Furthermore, the console may, on a periodic or continuous basis, store the current state of the timer in non-volatile memory 760. For example, the current value of the timer may be stored in NVM every 5 minutes to persist the current state of the timer in the event of power loss. Persisting the timer value is useful, for example, to prevent a user from continuously resetting the timer value near the end of the allocated time interval.

When multiple potential users are involved, for example when a user has several children who may use the entertainment console, the user may desire to provide different time control settings for each child. In such cases, an embodiment of the present disclosure may provide a module for configuring a unique time control profile for each of a plurality of users, thus allowing parents to establish different play time allocations to different children. A unique time control profile may be invoked each time a different user logs into the console.

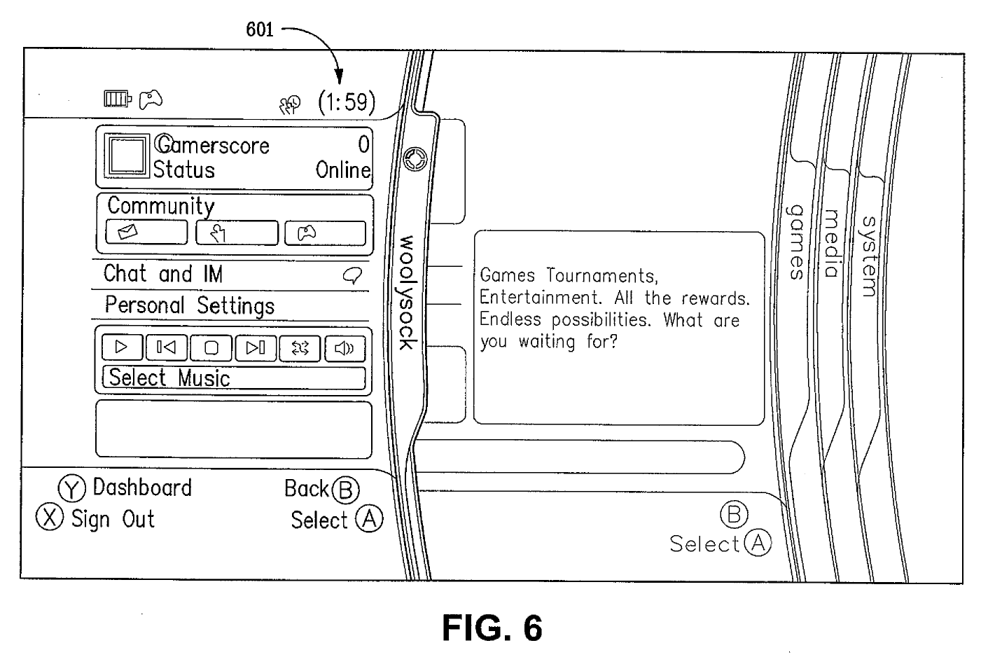

It may be further desirable that any time a user is using the console, the user may easily be able to access a user interface and check to see how much time they have left to play. Depicted in FIG. 6 is an exemplary user interface that provides a current time remaining 601 and timer access in conjunction with various other features and controls. When provided with the current timer allocation in this manner, the user may more conveniently choose to begin an application, or navigate to the family settings area to update the timer settings.

In another embodiment, if the console is configured to communicate to a network such as a local area network or communicate on the internet, Internet browser tools for managing the timer control data may be provided online. A web based scheduler may be provided that can provide access to the timer control settings from a remote location. Alternatively, the timer control settings may be provided to a centralized location such as a game server that provides services for a particular family of consoles. If the console is configured to communicate to such a web based service, parents can schedule time on the console through a web page provided for establishing and modifying a play time.

Furthermore, a user interface may be provided for parents to learn how much of the allocated time their children have been using. For example, the timer may be used to track a player's game playing time over a period of time. Thus a user may determine if a particular timer setting is consistently used or if a timer allocation is typically not used. Playing time can further be tracked using a cumulative play timer that tracks user time on a continuous basis or for a specified time period. Such a feature may be useful for monitoring a user's console usage over an extended time period. In some embodiments the user may be provided a notification that their cumulative play time has exceeded a predetermined amount.

The timer control function is not necessarily limited to managing access to video games. Such a function may manage not just video game consumption, but any of the various media options that the console provides.

Finally, in a further embodiment the console may provide an application programming interface (API). The API may provide an interface through which various applications executing on the console can request information regarding the current time control data settings and the current state of the timer. Such an API may provide the following information to requesting applications:

1. current time

2. time remaining in play timer

3. how much time has been allocated daily/weekly

4. timer history

5. timer statistics

For example, the current game being played by a user can call the API to determine whether the timer has been set, and if so, how much time is left on the timer. Such an API can enable an application to display its own timer notifications that may be better coordinated and synchronized with the unique aspects of the particular application. For example, a particular video game may typically consume a minimum amount of time to advance to the next level of achievement, and if the application determines that there is not enough time to complete the next level, the application may display a message such as “You have insufficient time to complete the next level. Do you want to save now?” Other applications may similarly use the API to access the time related data and provide useful features as part of the particular application.

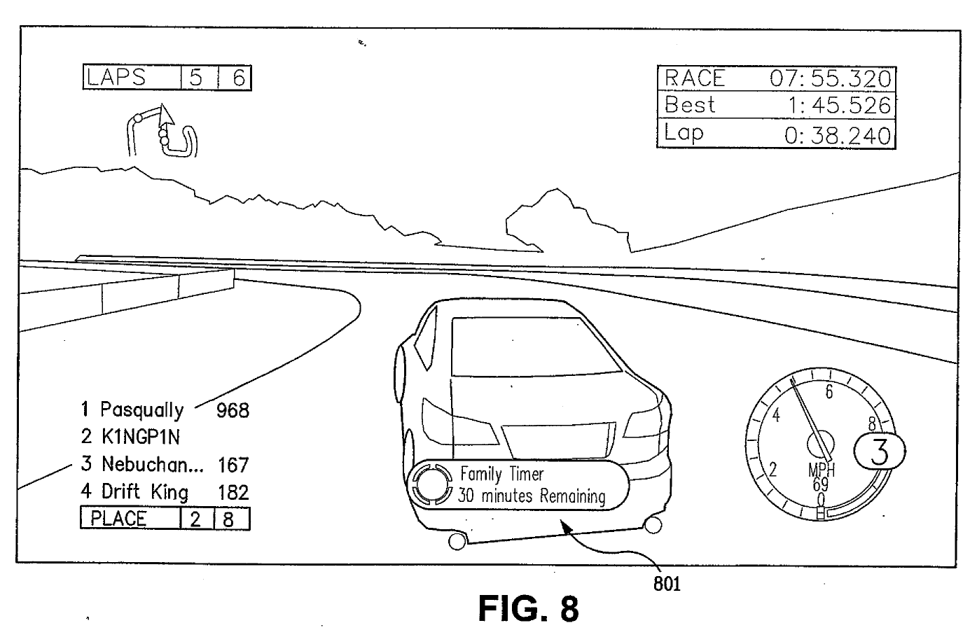

As shown in FIG. 8, a non-intrusive notification 801 may be displayed when the timer reaches 30 minutes remaining, for example. Notifications may also be provided as the timer reaches other predetermined limits. The period of time that the notification is displayed may be determined by the particular game or application. As discussed, the application may request various types of information in order to provide appropriate notifications, and may display other information depending upon the particular application. Furthermore, the application may choose to temporarily “freeze” the application and request that the user acknowledge the notification. The API thus provides to an application the option of requesting information suitable for the particular needs of the application.

Exemplary Game Console, PC, and Networking Aspects

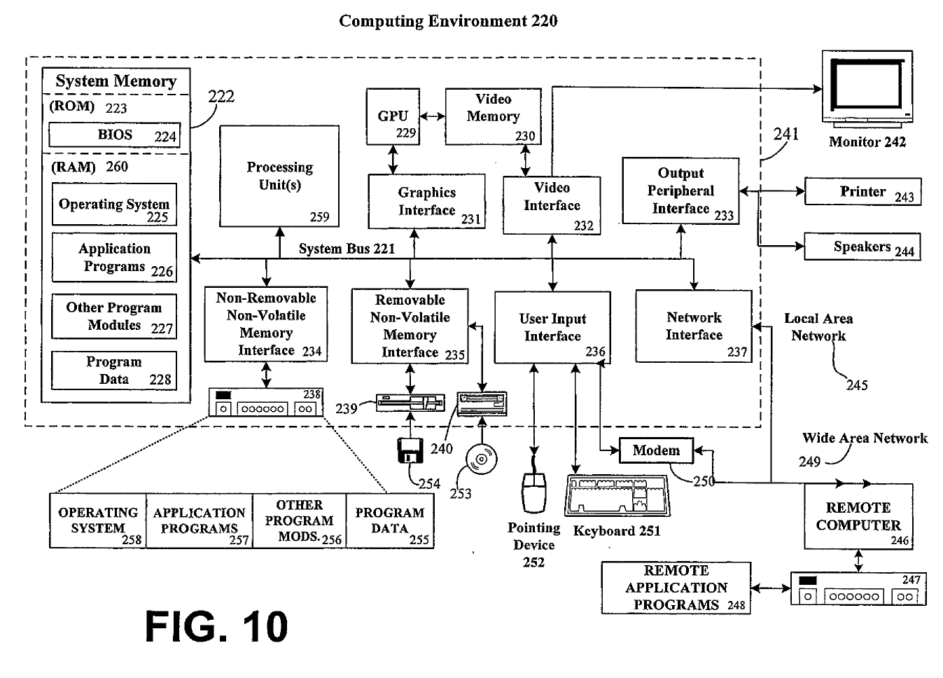

This section of the present disclosure provides the general aspects of an exemplary and non-limiting game console. Referring now to FIG. 10, a block diagram shows an exemplary multimedia console. The multimedia console 100 has a central processing unit (CPU) 101 having a level 1 (L1) cache 102, a level 2 (L2) cache 104, and a flash ROM (Read-only Memory) 106. The level 1 cache 102 and level 2 cache 104 temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase may be stored in a flash memory device (not shown). Furthermore, ROM 106 may be located separate from CPU 101.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity, 3D, surround, and stereo audio processing according to aspects of the present disclosure described above. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community. In this latter scenario, the console 100 may be connected via the network 330 of FIG. 1 to the server PC 300.

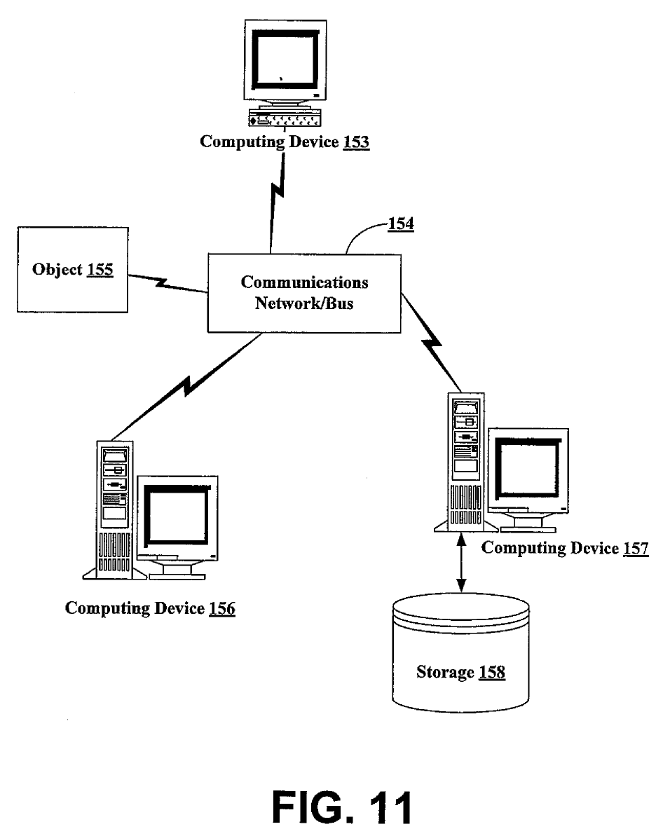

Second, now turning to FIG. 11, illustrated is a block diagram representing an exemplary computing device that may be suitable for use in conjunction with implementing the subject matter disclosed above. For example, the computer executable instructions that carry out the processes and methods for providing PC experiences on gaming consoles may reside and/or be executed in such a computing environment as shown in FIG. 10. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220.

Computer 241 typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 11 illustrates operating system 225, application programs 226, other program modules 227, and program data 228.

The computer 241 may also include other removable/non-removable, volatile/nonvolatile computer storage media. By way of example only, FIG. 11 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 11, provide storage of computer readable instructions, data structures, program modules and other data for the computer 241. In FIG. 11, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 11. The logical connections depicted in FIG. 11 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 11 illustrates remote application programs 248 as residing on memory device 247. It will be appreciated that the network connections shown are exemplary and other means of establishing a communications link between the computers may be used.

FIG. 12 provides a schematic diagram of an exemplary networked or distributed computing environment. The environment comprises computing devices 153, 156, and 157 as well as object 155 and database 158. Each of these entities 153, 155, 156, 157, and 158 may comprise or make use of programs, methods, data stores, programmable logic, etc. The entities 153, 155, 156, 157, and 158 may span portions of the same or different devices such as PDAs, audio/video devices, MP3 players, smart phones, DVD players, cable box tuners, or just about any computing devices capable of remoted content provided by server PCs. Each entity 153, 155, 156, 157, and 158 can communicate with another entity 153, 155, 156, 157, and 158 by way of the communications network 154. In this regard, any entity may be responsible for the maintenance and updating of a database 158 or other storage element.

This network 154 may itself comprise other computing entities that provide services to the system of FIG. 12, and may itself represent multiple interconnected networks. In accordance with an aspect of the presently disclosed subject matter, each entity 153, 155, 156, 157, and 158 may contain discrete functional program modules that might make use of an API, or other object, software, firmware and/or hardware, to request services of one or more of the other entities 153, 155, 156, 157, and 158.

It can also be appreciated that an object, such as 155, may be hosted on another computing device 156. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 12, any entity 153, 155, 156, 157, and 158 can be considered a client, a server, or both, depending on the circumstances. And, moreover, regarding the entertainment console, it can be a client to a server.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 12 and the further diversification that can occur in computing in a network environment such as that of FIG. 12, the systems and methods provided herein cannot be construed as limited in any way to a particular computing architecture or operating system. Instead, the presently disclosed subject matter should not be limited to any single embodiment, but rather should be construed in breadth and scope in accordance with the appended claims. Thus, for example, although game consoles and server PCs have been discussed, just as easily full desktops could be remoted to smart phones as a means to access data and functionality that is otherwise unavailable to smart phones.

Finally, it should also be noted that the various techniques described herein may be implemented in connection with hardware or software or, where appropriate, with a combination of both. Thus, the methods, computer readable media, and systems of the presently disclosed subject matter, or certain aspects or portions thereof, may take the form of program code (i.e., instructions) embodied in tangible media, such as floppy diskettes, CD-ROMs, hard drives, or any other machine-readable storage medium, where, when the program code is loaded into and executed by a machine, such as a computer, the machine becomes an apparatus for practicing the subject matter.

In the case of program code execution on programmable computers, the computing device may generally include a processor, a storage medium readable by the processor (including volatile and non-volatile memory and/or storage elements), at least one input device, and at least one output device. One or more programs that may utilize the creation and/or implementation of domain-specific programming models aspects of the present disclosure, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

Lastly, while the present disclosure has been described in connection with the preferred aspects, as illustrated in the various figures, it is understood that other similar aspects may be used or modifications and additions may be made to the described aspects for performing the same function of the present disclosure without deviating there from. For example, in various aspects of the disclosure, the providing of time based control of entertainment consoles was disclosed. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for providing time-based user access control native to an entertainment console, comprising:
a module configured to provide time-based user access control options to a first user;
a module configured to receive time control data from said first user and store said time control data in persistent memory, said time control data comprising at least a time budget and a time interval;
a module configured to track a total time during which a second user accesses at least one application on said entertainment console;
a module configured to manage said second user's access to said entertainment console based upon said total time and said time control data; and
a module configured to provide notifications to said second user regarding an amount of time remaining.

2. The system of claim 1, further comprising a module configured to synchronize said time control data and said total time with a system clock or an Internet based clock as a reference time.

3. The system of claim 1, further comprising a module configured to receive a security code for accessing and modifying said timer control data.

4. The system of claim 1, further comprising a module configured to provide an application programming interface (API) for requesting and transmitting said timer control data and said total time.

5. The system of claim 1, further comprising a module configured to automatically add said time budget at the beginning of said time interval.

6. The system of claim 1 wherein said time control data further comprises at least one of the group consisting of: a timer expiration date; a daily time budget to be added each day; a weekly time budget to be added each week; at least one day of the week and a time budget for each of said at least one day of the week; and a time interval during which access is restricted.

7. The system of claim 1, further comprising a module configured to provide said first user with the option of entering time control data from a personal computer via a web browser.

8. A method for providing time-based user access control of an entertainment console, comprising:
providing time-based user access control options;
receiving time control data and storing said time control data in persistent memory, said time control data comprising at least a time budget and a time interval;
synchronizing said time control data and said total time with a system clock or an Internet based clock as a reference time;
tracking a total time during which an access is made to at least one application on said entertainment console as a function of said reference time; and
managing said access to said entertainment console based upon said total time and said time control data.

9. The method according to claim 8 further comprising automatically adding said total time budget at the beginning of said each time interval.

10. The method according to claim 8, further comprising receiving a security code for accessing and modifying said time control data.

11. The method according to claim 8, further comprising providing an application programming interface (API) for requesting and transmitting said timer control data and an amount of time remaining.

12. The method according to claim 8, further comprising providing notifications regarding an amount of time remaining.

13. The method according to claim 8 wherein said time control data further comprises at least one of the group:
a timer expiration date; a daily time budget to be added each day; a weekly time budget to be added each week; at least one day of the week and a time budget for each of said at least one day of the week; and a time interval during which access is restricted.

14. The method according to claim 8, further comprising updating and storing a cumulative time for said second user.

15. The method according to claim 8, further comprising providing said time-based user access control for a plurality of user profiles.

16. A computer readable medium storing thereon computer executable instructions for providing time-based user access control native to an entertainment console, comprising:
instructions for providing time-based user access control options to a first user;
instructions for receiving a security code for accessing and modifying said time control data;
instructions for receiving time control data from said first user and storing said time control data in persistent memory, said time control data comprising at least a time budget and a time interval;
instructions for synchronizing said time control data and said total time with a system clock or an Internet based clock as a reference time;
instructions for tracking a total time during which a second user accesses at least one application on said entertainment console as a function of said reference time; and
instructions for managing said second user's access to said entertainment console based upon said total time and said time control data.

17. The computer readable medium according to claim 16, further comprising instructions for providing an application programming interface (API) for requesting and transmitting said timer control data and an amount of time remaining.

18. The computer readable medium according to claim 16, further comprising instructions for providing notifications to said second user regarding an amount of time remaining.

19. The computer readable medium according to claim 16 wherein said time control data further comprises at least one the group: a timer expiration date; a daily time budget to be added each day; a weekly time budget to be added each week; at least one day of the week and a time budget for each of said at least one day of the week; and a time interval during which access is restricted.

20. The computer readable medium according to claim 16, further comprising instructions for updating and storing a cumulative time for said second user.
